(19) United States
(12) Patent Application Publication
(10) Pub. No.: US 2010/0275740 A1
(43) Pub. Date: Nov. 4, 2010

(54) RETAINING MECHANISM

(76) Inventor: Mats Norin, Alvdalen (SE)

Correspondence Address: DICKSTEIN SHAPIRO LLP, 1825 EYE STREET NW, Washington, DC, 20006-5403, US

(21) Appl. No.: 12/725,530

(22) Filed: Mar. 17, 2010

(30) Foreign Application Priority Data
Apr. 30, 2009 (SE) 0900584-4

(51) Int. Cl. B25B 7/14

(52) U.S. Cl. 81/338

(57) ABSTRACT

Retaining mechanism for use with a handheld tool comprising first and second handle element parts (1, 2) being pivotally connected (3) to each other, and a pawl and ratchet arrangement. A rack of teeth (5) is arranged on a first arm (4) mounted on the first handle element part (1) and a pawl (6) is arranged on a free end of a second arm (7), which is mounted on the second handle element part (2), at least one of said first and second arms (4, 7) being flexible. Said first and second arms (4, 7) are arranged to move adjacent to each other when the handle element parts are squeezed together.

### FIELD OF INVENTION

The present invention relates to a retaining mechanism according to the preamble of claim 1.

### PRIOR ART

Handheld tools such as crimping tools are often equipped with a pawl and ratchet mechanism, the main object of which is to assure that an intended working cycle is completed. An accompanying advantage with these pawl and ratchet mechanisms is that they make it possible to maintain the handles in a squeezed together condition when the grip is released. There are a number of previously known technical solutions for achieving this, but they are often quite complicated. This adds to the manufacturing cost and also the assembly costs.

Another drawback with tools in the market is that in order to loosen the grip of the tool, the handles must be squeezed together into a predetermined relative position corresponding to a completed working cycle, whereupon the retaining mechanism will be released.

Accordingly, there is a need of an improved retaining mechanism.

### THE INVENTION

The object of the invention is to provide an improved retaining mechanism for two pivotally fixed handles of a handheld tool with which the drawbacks of prior art devices are mitigated.

This and other objects are achieved with the retaining mechanism as defined in claim 1. Preferred embodiments and developments of the invention are defined in the dependent claims.

### SHORT DESCRIPTION OF DRAWINGS

The invention will now be described more in detail in connection with a preferred embodiment of the invention with reference to the accompanying drawing, in which

FIG. 1 is a schematic view in perspective of one embodiment of the retaining mechanism according to the invention,

FIG. 2 is a schematic side view of the mechanism shown in FIG. 1, and

FIG. 3 is a schematic side view of a handheld tool incorporating the retaining mechanism according to the invention.

### DETAILED DESCRIPTION OF THE INVENTION

The retaining mechanism according to the invention is designed to be used with handheld tools such as pliers of different kinds, and especially with crimping tools, having two handles being pivotally connected to each other.

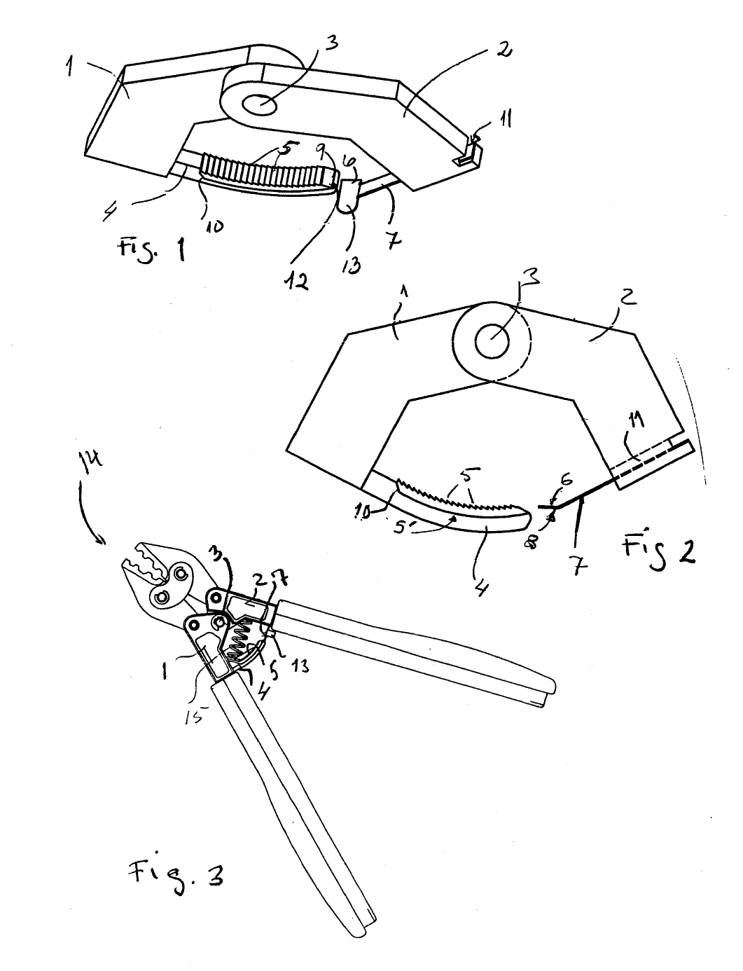

In FIG. 1 and FIG. 2, the retaining mechanism according to the invention is illustrated as a first and second handle element part 1 and 2, respectively. The handle element parts are connected to each other through a pivot pin 3. Depending on the tool the handles will extend in different forms and shapes on the “other side” of the pivot connection. A handheld crimping tool is illustrated in FIG. 3 as one example, but the inventive concept is not restricted to crimping tools.

The retaining mechanism according to the invention thus comprises said two handle element parts 1 and 2, and a pawl and ratchet arrangement acting between said element parts.

On the first handle element part 1 is arranged a first arm 4 carrying a rack of teeth 5 extending over part of said arm, leaving an empty space between said first handle element part 1 and said rack of teeth. On the second handle element part 2 is arranged a pawl 6 mounted on or being an integral part of a second arm 7. Accordingly, the pawl and the second arm are in fact one and the same element, which is an important improvement in view of prior art devices.

The first arm 4 carrying the rack of teeth is preferably curved corresponding to the swivelling motion of the handle element parts around the pivot pin 3.

In a preferred embodiment, as shown in FIGS. 1 and 2, the rack of teeth protrudes laterally (at 12) beyond the first arm and exhibits an even surface 5′ on the opposite side from the teeth 5.

On the end of the first arm 4 is arranged a first guide surface 8 sloping upwards towards the rack of teeth. The end of the second arm 7 is formed with a corresponding second guide surface 9 pointing upwards.

Said arms are arranged on said handle element parts with their longitudinal axes parallel to each other and offset so that when said handle element parts are squeezed together they will move adjacent to each other. The pawl extends laterally from the flexible arm so that it will slide up onto the rack of teeth, and when the handle element parts are squeezed together the pawl will jump over the rack of teeth one by one, and when the squeezing force is released the pawl will be arrested on one of the teeth.

At least one of said first and second arms 4, 7 is flexible. In a preferred embodiment, which is illustrated on the drawing, the second arm incorporating the pawl 6 is flexible.

However, in the mechanism according to the invention the arm carrying the rack of teeth could be the flexible arm, or both arms could be flexible.

When the flexible arm is bent and the pawl is guided up onto the rack of teeth it will exert an elastic force and the pawl will be biased against the teeth with a sufficient pressure to keep the pawl in contact with the rack of teeth.

At the inner end of said rack of teeth, a third guide surface 10 is arranged. When the pawl has passed the last tooth of the rack of teeth, the elastic force will make the pawl to move along said third guide surface, and the handle element parts will be free again to move away from each other. During this return movement the pawl will move freely along the even surface. This might take place without any tension from the flexible arm, or the flexible arm may exert a small force against said even surface, so that its guide surface will overlap with the above mentioned second guide surface on the end of the rigid arm.

Preferably, a groove 11 is arranged in the second handle element part 2, in which groove the protruding part 12 of the rack of teeth can move freely when the handle element parts are squeezed together, and then are returned again.

In the embodiment illustrated on the drawings the rack of teeth is arranged on the inside of the rigid arm 4, i.e. on the side facing the pivot connection between the handle element parts 1 and 2. However, it would also be possible to arrange the rack of teeth on the outside of the rigid arm with a corresponding adaption of the guide surfaces for guiding the pawl downwards onto the rack of teeth and then upwards onto the even surface on the opposite side from the rack of teeth.

With reference to FIGS. 1 and 3 a laterally protruding tab 13 is arranged on the flexible arm. With the aid of this tab 13 the pawl can be manually disengaged from the rack of teeth at any point of e.g. a crimping process. The tab 13 may be arranged adjacent to the pawl or else distanced from the pawl on the flexible arm, as is illustrated in FIG. 3.

In FIG. 3 the retaining mechanism is illustrated in connection with a crimping tool 14. A coil spring 15 is arranged between the first and second handle element parts 1, 2. when the pawl 6 has passed the last tooth of the rack of teeth and the grip of the handles is released, the coil spring will push the first and second handle element parts away from each other, the pawl will slide along the third guide surface and the tool will be returned to the start position.

What is claimed is:

1. Retaining mechanism for use with a handheld tool comprising first and second handle element parts (1, 2) being pivotally connected (3) to each other, and a pawl and ratchet arrangement comprising of rack of teeth (5) in connection with the first handle element part (1) and a pawl (6) in connection with the second handle element part (2) arranged to engage with the rack of teeth when the handle element parts (1, 2) are squeezed together, characterized in that
the rack of teeth (5) is arranged on a first arm (4), which is mounted on the first handle element part (1) and extended towards the second handle element part (2),
the pawl (6) is arranged on a free end of a second arm (7), which is mounted on the second handle element part (2) and extended towards said first handle element part (1), and
in that at least one of said first and second arms (4, 7) are flexible
said first and second arms (4, 7) being arranged to move adjacent to each other when the handle element parts are squeezed together.

2. Retaining mechanism according to claim 1, characterized in that the pawl (6) is an integral part of said second arm (7).

3. Retaining mechanism according to claim 1,
characterized in that an outer end of the second arm (7) is formed as a first guide surface (8), an outer end of the first arm (4) is formed as a second guide surface (9) adapted to the first guide surface on the second arm, and which guide surfaces guide the pawl (6) onto the rack of teeth (5) when the handle element parts (1, 2) are squeezed together.

4. Retaining mechanism according to claim 1,
characterized in that an inner end of the rack of teeth has a third guide surface (10) which guides the pawl (6) onto an even surface (5′) on the underside of a laterally protruding part (12) of the rack of teeth (5), when the pawl (6) has reached the end of the rack of teeth.

5. Retaining mechanism according to claim 1,
characterized in that said at least one flexible arm (7) has a laterally protruding tab (13) for manual disengagement of the pawl (6) from the rack of teeth (5), when the pawl (6) is arrested between the ends of said rack of teeth (5).

6. Retaining mechanism according to claim 1,
characterized in that the second arm (7) carrying the pawl (6) is flexible.
